(19) United States
(12) Patent Application Publication
(10) Pub. No.: US 2019/0155128 A1
(43) Pub. Date: May 23, 2019

(54) PROJECTION LENS AND PROJECTOR

(71) Applicant: FUJIFILM Corporation, Tokyo (JP)

(72) Inventor: Hitoshi SHIMIZU, Saitama (JP)

(73) Assignee: FUJIFILM Corporation, Tokyo (JP)

(21) Appl. No.: 16/252,578

(22) Filed: Jan. 19, 2019

Related U.S. Application Data
(63) Continuation of application No. PCT/JP2017/024448, filed on Jul. 4, 2017.

(30) Foreign Application Priority Data
Jul. 21, 2016 (JP) 2016-143207

(51) Int. Cl. G03B 11/00; G02B 13/16; G03B 21/14; G03B 21/28

(52) U.S. Cl. CPC G03B 11/00; G02B 13/16; H04N 9/3185; G03B 21/28; G03B 21/145; G03B 21/142

(57) ABSTRACT

A projection lens is shifted in the direction of an arrow A1 by a shift mechanism to change the position of a projection image on a screen. A first optical system forms an image of an image display panel on an intermediate imaging plane. A second optical system projects the image, which is formed on the imaging plane, onto the screen. A warning indicator member includes a mask and a warning mark, and is disposed on the imaging plane of the first optical system. The warning mark is formed at a portion of the warning indicator member where an image frame of an intermediate image is hidden by the mask. In a case in which the projection lens is excessively shifted, the image of the warning mark is displayed on the screen. Accordingly, a user can reliably know that a part of an image is missed.

### CROSS-REFERENCE TO RELATED APPLICATIONS

This application is a Continuation of PCT International Application No. PCT/JP2017/024448 filed on 4 Jul. 2017, which claims priority under 35 U.S.C § 119(a) to Japanese Patent Application No. 2016-143207 filed on 21 Jul. 2016. The above application is hereby expressly incorporated by reference, in its entirety, into the present application.

### BACKGROUND OF THE INVENTION

### 1. Field of the Invention

The present invention relates to a projection lens and a projector.

### 2. Description of the Related Art

A projector, which projects an image onto a screen and includes a lens shift mechanism adjusting the projection position of the image on the screen, is known (JP2005-331642A, JP2005-173460A, and JP2012-177846A). The lens shift mechanism moves a projection lens with respect to, for example, an image display panel, which displays the image to be projected onto the screen, in a direction orthogonal to an optical axis.

If the moving distance of the projection lens is long in a case in which the projection lens is shifted in the projector including the lens shift mechanism, a part of the projection lens deviates from the display surface of the image display panel. Accordingly, there is a problem that a part of a screen projected onto the screen is omitted. For this reason, in the projector disclosed in JP2005-331642A, whether or not the projection lens is present in a predetermined slide limitation area is detected by a sensor and the shift distance of the projection lens is limited. Further, in the projector disclosed in JP2005-173460A, a movable resistor is used to convert a change in the position of the projection lens into a voltage and the movement of the projection lens is regulated on the basis of a change in the voltage. In the projector disclosed in JP2012-177846A, the shift of the projection lens performed by the lens shift mechanism is controlled so that the entire area of the image display panel after the shift of the projection lens is in the range of an effective image display area.

### SUMMARY OF THE INVENTION

In a projector of which a projection lens can be interchanged, the projection lens is attachably and detachably mounted on a projector body. The shift distance of the lens of such a lens-interchangeable projector is defined as the lens shift distance of the projector body without any exception. Accordingly, since a projection lens having a large diameter is needed in a case in which various interchangeable projection lenses are adapted to cover the entire lens shift distance of the projector body, the projector is increased in size. For this reason, there is a case in which an allowable shift distance is limited in the lens-interchangeable projector to reduce the size of a lens. In this case, an excessive shift where a lens is shifted over the allowable shift distance of a lens in the projector body is likely to occur. For this reason, there is a problem that a part of a screen projected onto the screen is omitted.

Further, even though a projection lens of which an allowable shift distance in a wide mode (wide angle) is different from an allowable shift distance in a telephoto mode is used as a zoom lens unlike in the lens-interchangeable projector, there is a problem that a part of a screen projected onto the screen is omitted likewise.

Since the shift distance of the lens is limited by some means in each of JP2005-331642A, JP2005-173460A, and JP2012-177846A, a sensor for detecting the shift distance is required or a control unit for determining whether or not a shift distance is in an appropriate range is required. For this reason, a structure becomes complicated. Accordingly, there is a demand on a simple structure that can prevent a part of a projection image from being missed.

The invention has been made in consideration of the above-mentioned circumstances, and an object of the invention is to provide a projection lens and a projector that can prevent a part of a projection image from being missed by limiting a relative shift of a projection lens and an image display panel with a simple structure.

In order to achieve the object, la projection lens of the invention projects an image of an image display panel onto a projection surface and is used for a projector shifting one of the image display panel and the projection lens in a direction orthogonal to an optical axis to adjust a projection position of the image on the projection surface. The projection lens comprises a first optical system, a second optical system, and a warning indicator member. The first optical system forms the image of the image display panel. The second optical system projects the image, which is formed by the first optical system, onto the projection surface. The warning indicator member displays an outside of a projection range of the image depending on the shift of one of the image display panel and the projection lens in a direction orthogonal to an optical axis of the first optical system.

It is preferable that the warning indicator member is provided on an imaging plane on which the image is formed by the first optical system.

It is preferable that the warning indicator member includes a mask and a warning mark. The mask includes an opening regulating the projection of the image. The warning mark is formed at a portion of the warning indicator member where the image is hidden by the mask due to the shift of one of the image display panel and the projection lens.

It is preferable that the first optical system or the second optical system includes a zooming mechanism and an interlocking mechanism. The zooming mechanism displaces some lenses in an optical axis direction to change a projection magnification. The interlocking mechanism displaces the warning indicator member in the direction, which is orthogonal to the optical axis, to position the warning mark at the portion of the warning indicator member where the image is hidden by the mask while interlocking with the displacement of the some lenses in the optical axis direction that is performed by the zooming mechanism.

It is preferable that the projection lens further includes a first reflective member, a second reflective member, and a lens barrel. The first reflective member is disposed so as to be inclined with respect to a first optical axis of the first optical system and reflects the first optical axis to form a second optical axis. The second reflective member is provided in the second optical system, is disposed so as to be inclined with respect to the second optical axis, and reflects the second optical axis to form a third optical axis parallel to the first optical axis in a plane including the first optical axis and the second optical axis. The lens barrel holds the first optical system, the first reflective member, the second reflective member, the second optical system, and the warning indicator member.

A projector of the invention comprises the projection lens, the image display panel, a light source, a shift mechanism, and a housing. The image display panel displays the image. The light source illuminates the image display panel. The shift mechanism shifts one of the image display panel and the projection lens in the direction orthogonal to the optical axis. The housing stores the image display panel, the light source, and the shift mechanism. It is preferable that the projection lens is attachably and detachably mounted on the housing.

According to the invention, it is possible to prevent a part of a projection image from being missed by limiting a relative shift of a projection lens and an image display panel with a simple structure.

### BRIEF DESCRIPTION OF THE DRAWINGS

FIG. 1 is a perspective view of a projector of the invention.

FIG. 2 is a front view of a shift mechanism that is viewed from an image display panel in a first optical axis direction.

FIG. 3 is a longitudinal sectional view of the projector.

FIG. 4 is a schematic diagram in which a U-shaped optical axis of a projection lens of FIG. 3 is unfolded to a linear optical axis.

FIG. 5 is a cross-sectional view of a warning indicator member taken along line V-V of FIG. 3.

FIG. 6 is a front view of a warning mark image that is projected onto a screen.

FIG. 7 is a front view showing a state in which a part of the warning mark image is projected.

FIG. 8 is a cross-sectional view corresponding to line V-V of FIG. 3 and showing Modification example 1 of the warning indicator member that also includes a warning mark provided on a long side of an opening of a mask facing a warning mark.

FIG. 9 is a cross-sectional view corresponding to line V-V of FIG. 3 and showing Modification example 2 of the warning indicator member that includes a strip-shaped warning mark provided on the long side of the opening of the mask.

FIG. 10 is a cross-sectional view corresponding to line V-V of FIG. 3 and showing Modification example 3 of the warning indicator member that includes a warning mark formed of a pair of triangles facing each other and provided on the long side of the opening of the mask.

FIG. 11 is a cross-sectional view corresponding to line V-V of FIG. 3 and showing Modification example 4 of the warning indicator member that includes a warning mark formed of a plurality of arranged triangles and provided on the long side of the opening of the mask.

FIG. 12 is a cross-sectional view corresponding to line V-V of FIG. 3 and showing Modification example 5 of the warning indicator member that includes a warning mark formed of no-entry marks and provided on the long side of the opening of the mask.

FIG. 13 is a cross-sectional view corresponding to line V-V of FIG. 3 and showing Modification example 6 of the warning indicator member that includes a warning mark including a plurality of triangular protrusions and provided on the long side of the opening of the mask.

FIG. 14 is a longitudinal sectional view of a projection lens of a second embodiment including a zooming mechanism.

FIG. 15 is a front view of a warning indicator member of the second embodiment that is set on a telephoto-side.

FIG. 16 is a front view of the warning indicator member of the second embodiment that is set on a wide-side.

### DESCRIPTION OF THE PREFERRED EMBODIMENTS

### First Embodiment

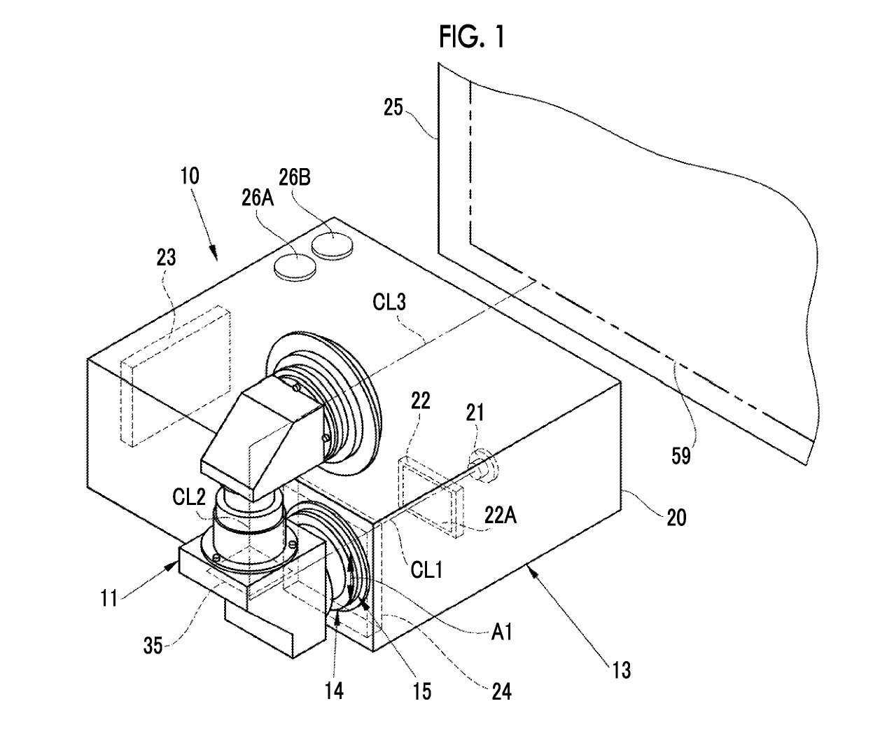

As shown in FIG. 1, a projector 10 of this embodiment comprises a projection lens 11 and a projector body 13. The projection lens 11 is attachably and detachably mounted on the projector body 13 through mounts 14 and 15. The projector body 13 comprises a housing 20 having the shape of a substantially rectangular parallelepiped. A light source 21, an image display panel 22, a control unit 23, and a shift mechanism 24 are stored in the housing 20. Further, a shift dial 26A and a focus dial 26B are provided on the upper surface of the housing 20.

The image display panel 22 is formed of a transmission-type liquid crystal panel and displays an image. The light source 21 is disposed on the back side of the image display panel 22, that is, the side of the image display panel 22 opposite to the projection lens 11. Light emitting diodes (LEDs) for emitting red (R) light, green (G) light, and blue (B) light, that is, light having three colors are used as the light source 21, and illuminate the image display panel 22. A xenon lamp, a halogen lamp, a super high-pressure mercury lamp, or the like, which emits white light, may be used instead of the LEDs. The projection lens 11 projects illumination light, which is emitted from the image display panel 22 illuminated by the light source 21, onto a projection surface, for example, a screen 25.

The control unit 23 turns on the light source 21 and allows an image, which has three colors of RGB, to be displayed on an image display surface 22A of the image display panel 22. The control unit 23 performs the following processing as well. For example, in a case in which the control unit 23 receives an operation signal of the shift dial 26A, the control unit 23 operates the shift mechanism 24. Accordingly, the projection lens 11, which is mounted on the housing 20 through the mounts 14 and 15, is shifted with respect to the housing 20 in a vertical direction as shown by an arrow A1. Further, in a case in which the control unit 23 receives an operation signal of the focus dial 26B, the control unit 23 operates a focus adjustment mechanism (not shown) for the projection lens 11. Accordingly, the focus of a projection image 59, which is projected onto the screen 25, is adjusted.

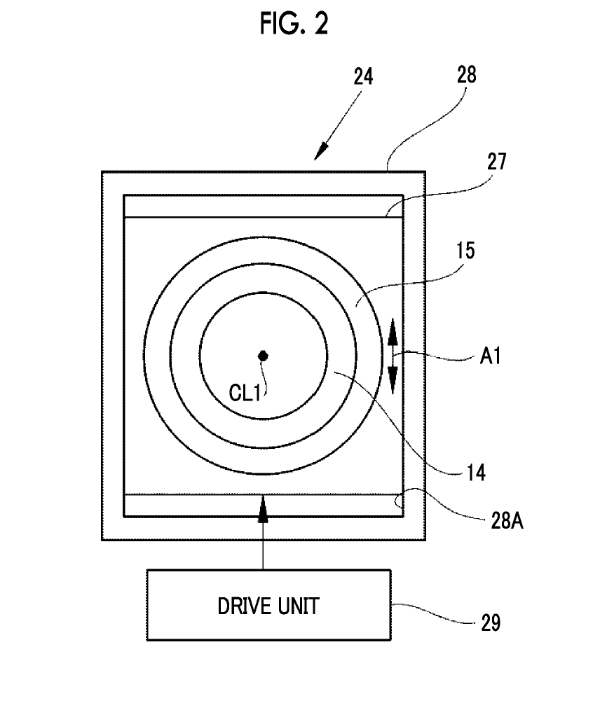

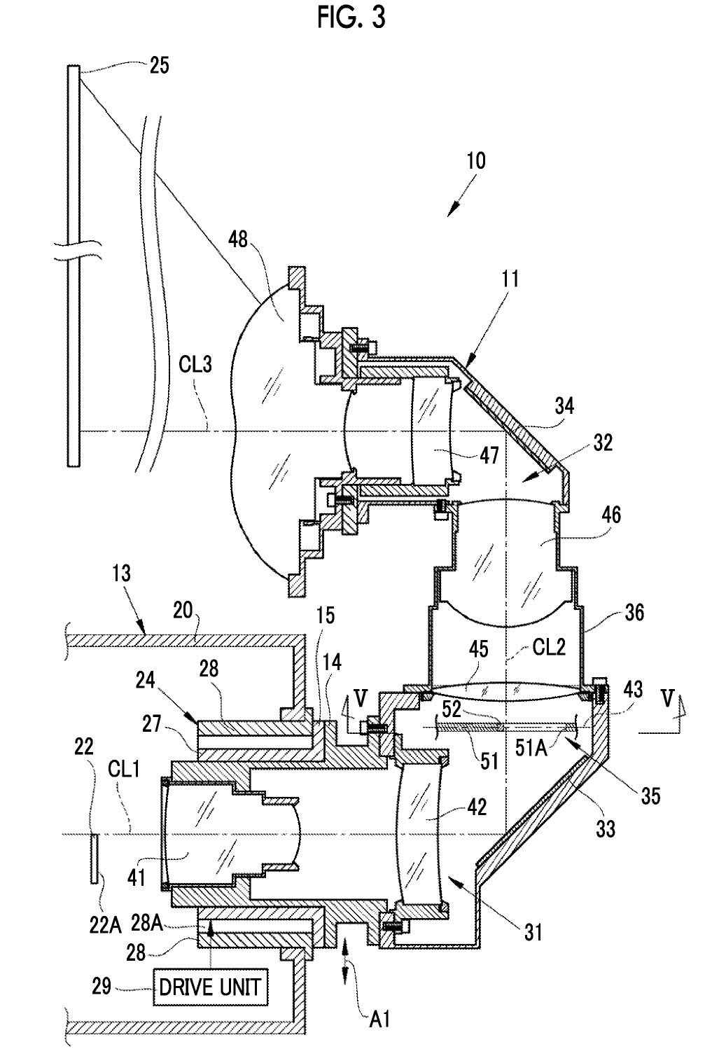

As shown in FIGS. 2 and 3, the shift mechanism 24 includes a lens holding block 27, a guide frame 28, and a drive unit 29. The lens holding block 27 is formed in the shape of a rectangular parallelepiped, and includes the mount 15. The mount 14 of the projection lens 11 is fitted to the mount 15. Accordingly, the lens holding block 27 and the projection lens 11 are integrated with each other. The guide frame 28 includes a guide groove 28A. The lens holding block 27 is stored in the guide groove 28A. The lens holding block 27 is held by the guide groove 28A so as to be slidable in the vertical direction. The drive unit 29 includes a motor (not shown), and moves up and down the lens holding block 27 by the drive of the motor. Accordingly, since the projection lens 11 is moved parallel to the vertical direction orthogonal to a first optical axis CL1, the lens can be shifted. Therefore, the projection position of the projection image 59 on the screen 25 can be adjusted in a state in which the projector 10 is fixed.

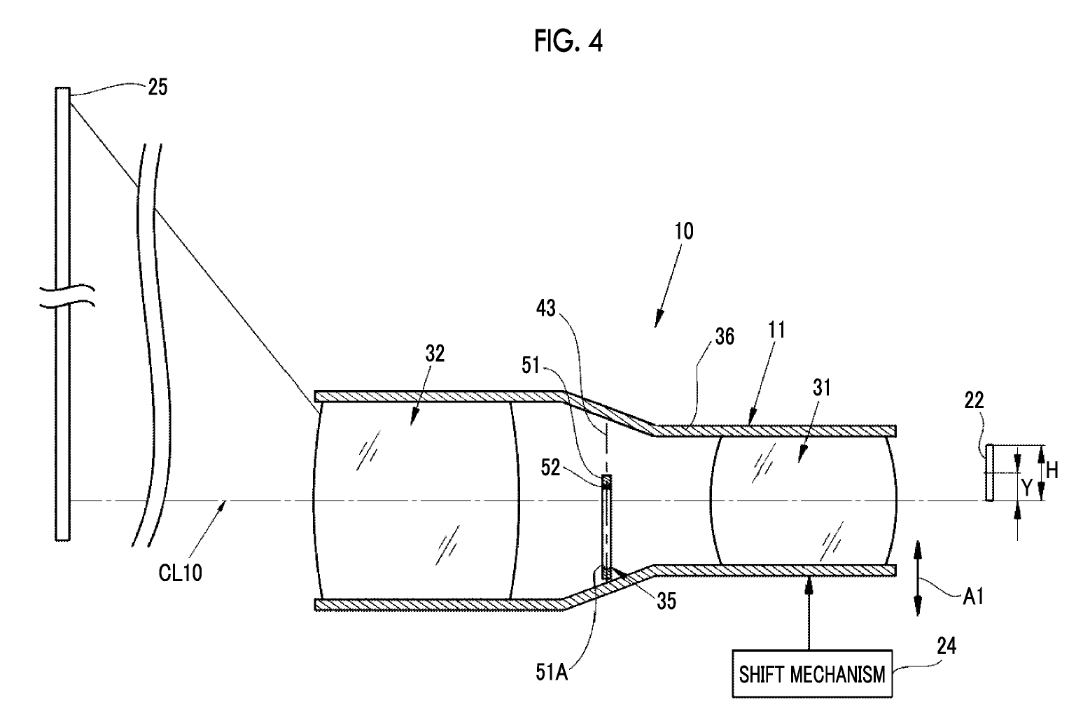

FIG. 4 is a schematic diagram in which a U-shaped optical axis of the projection lens 11 shown FIG. 3 is unfolded to a linear optical axis CL10. In a case in which a shift ratio in the vertical direction between the projection lens 11 and the image display panel 22 is 0.5, the linear optical axis CL10 of the projection lens 11 and the lower side of the projection image 59 can be made to coincide with each other. In a case in which a distance between the linear optical axis CL10 and the center of the image display panel 22 is denoted by Y and the length of the image display panel 22 in a lens-shift direction (the vertical direction) is denoted by H, the shift ratio is obtained by dividing the distance Y by the length H. In this embodiment, a gap between the linear optical axis CL1, and the lower side of the projection image 59 can be set to “0”. Accordingly, since a space corresponding to a set length does not need to be secured, not only the degree of freedom in the arrangement of the projector is increased but also this embodiment is advantageous in terms of a space in which the projector is to be disposed.

As shown in FIG. 3, the projection lens 11 comprises a first optical system 31, a second optical system 32, a first mirror 33 as a first reflective member, a second mirror 34 as a second reflective member, a warning indicator member 35, and a lens barrel 36.

The first optical system 31 is composed of a first lens 41 and a second lens 42. Each of these first and second lenses 41 and 42 is shown as a single lens for simplification in FIG. 3, but is actually composed of a lens group. The first optical system 31 forms an image, which is formed by the image display panel 22, on an imaging plane 43 as an intermediate image.

The first mirror 33 is disposed between the first optical system 31 and the imaging plane 43, on which the intermediate image is to be formed by the first optical system 31, so as to be inclined with respect to the first optical axis CL1 by an angle of 45°. The first mirror 33 reflects the first optical axis CL1 of the first optical system 31 at an angle of 90° to form a second optical axis CL2.

The second optical system 32 is composed of a third lens 45, a fourth lens 46, a fifth lens 47, and a sixth lens 48. Each of the fourth to sixth lenses 46 to 48 is shown as a single lens for simplification in FIG. 3, but is actually composed of a lens group. The second optical system 32 enlarges and projects the intermediate image, which is formed on the imaging plane 43 by the first optical system 31, onto the screen 25.

The second mirror 34 is disposed between the fourth lens 46 and the fifth lens 47 so as to be inclined with respect to the second optical axis CL2 by an angle of 45°. The second mirror 34 reflects the second optical axis CL2 at an angle of 90° to form a third optical axis CL3 parallel to the first optical axis CL1 in a plane that includes the first optical axis CL1 and the second optical axis CL2. The plane, which includes the first optical axis CL1 and the second optical axis CL2, includes, for example, a plane that crosses the plane at an intersecting angle of 15° or less and is substantially flat. Further, a case in which the first optical axis CL1 and the third optical axis CL3 are parallel to each other includes a case in which one of the first optical axis CL1 and the third optical axis CL3 is substantially parallel to the other thereof at an inclination angle of, for example, 15° or less.

The lens barrel 36 integrally holds the first optical system 31, the first mirror 33, the warning indicator member 35, the second optical system 32, and the second mirror 34. In the lens barrel 36, the U-shaped optical axis is formed by the second optical axis CL2, the incidence-side first optical axis CL1 of the first optical system 31, and the emission-side third optical axis CL3 of the second optical system 32. For this reason, since the lens barrel 36 is formed of a U-shaped lens barrel, the entire projector can be made compact.

As shown in FIG. 1, the projection image 59 is projected onto the screen 25 above the third optical axis CL3 of the projection lens 11. As shown in FIG. 3, the center of the image display panel 22 is fixed in a state in which the center of the image display panel 22 is shifted in a direction opposite to a direction in which the central position of the projection image 59 to be projected onto the screen 25 is shifted from the first optical axis CL1 of the projection lens 11, that is, shifted downward in the direction of the second optical axis CL2 of the projection lens 11.

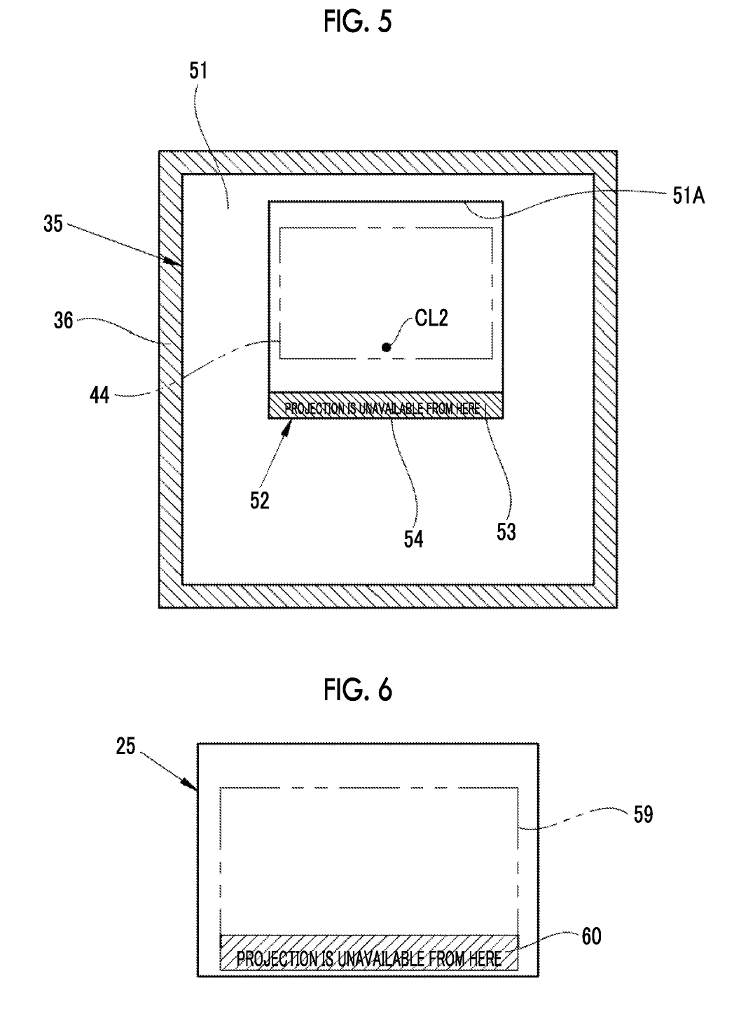

The warning indicator member 35 is disposed on the imaging plane 43 on which the intermediate image is to be formed by the first optical system 31. The warning indicator member 35 displays the outside of the projection range of the projection image 59 depending on the shift of the projection lens 11 or the image display panel 22 (in this example, the projection lens 11) in a direction orthogonal to the first optical axis CL1 of the first optical system 31. For this purpose, as shown in FIG. 5, the warning indicator member 35 includes a mask 51 and a warning mark 52.

The mask 51 is provided above the first mirror 33 on the same plane as the imaging plane 43 on which the intermediate image is to be formed by the first optical system 31. The mask 51 includes an opening 51A that regulates the projection of an image.

The warning mark 52 is formed at a portion of the warning indicator member where an image frame 44 of the intermediate image is hidden by the mask 51 due to the shift of the projection lens 11 in the vertical direction. As long as a warning mark image 60 (see FIG. 6) projected onto the screen 25 is clear without being blurred, the installation position of the mask 51 may be a position shifted from the imaging plane 43 or may be in a plane, which is substantially parallel to the imaging plane 43 and has an inclination angle with respect to the imaging plane 43, in addition to the same plane as the imaging plane 43.

In the warning mark 52, transparent characters 54 of “Projection is unavailable from here” are formed on a red filter 53, which is shown by hatching, as a base. In a case in which the projection lens 11 is excessively shifted when the projection lens 11 is to be shifted in the vertical direction orthogonal to the first optical axis CL1 of the first optical system 31, not only the image frame 44 of the intermediate image but also the projection image 59 is hidden by the warning mark 52. Instead of the transparent characters 54, the transparent characters 54 may be formed with each color other than a red color, which is the color of the base of the filter 53, or may be formed of opaque characters.

In a case in which the projection lens 11 is excessively shifted as shown in FIG. 6, the warning mark image 60 is projected onto the screen 25 at, for example, the lower portion of the projection image 59. The warning mark image 60 is the image of the warning mark 52 that is projected onto the screen 25, and is an image where the characters of “Projection is unavailable from here” caused by the transparent characters 54 stand out in a red base caused by the red filter 53. Since the warning mark image 60 is displayed on the screen 25, a user can reliably know that a part of an image is missed due to the excessive shift of the lens. Accordingly, it is possible to warn a user of a projection limit where a part of the projection image starts to be missed due to the shift of the lens. On the other hand, in a case in which the projection lens 11 is not excessively shifted, the warning mark image 60 is not projected onto the screen 25.

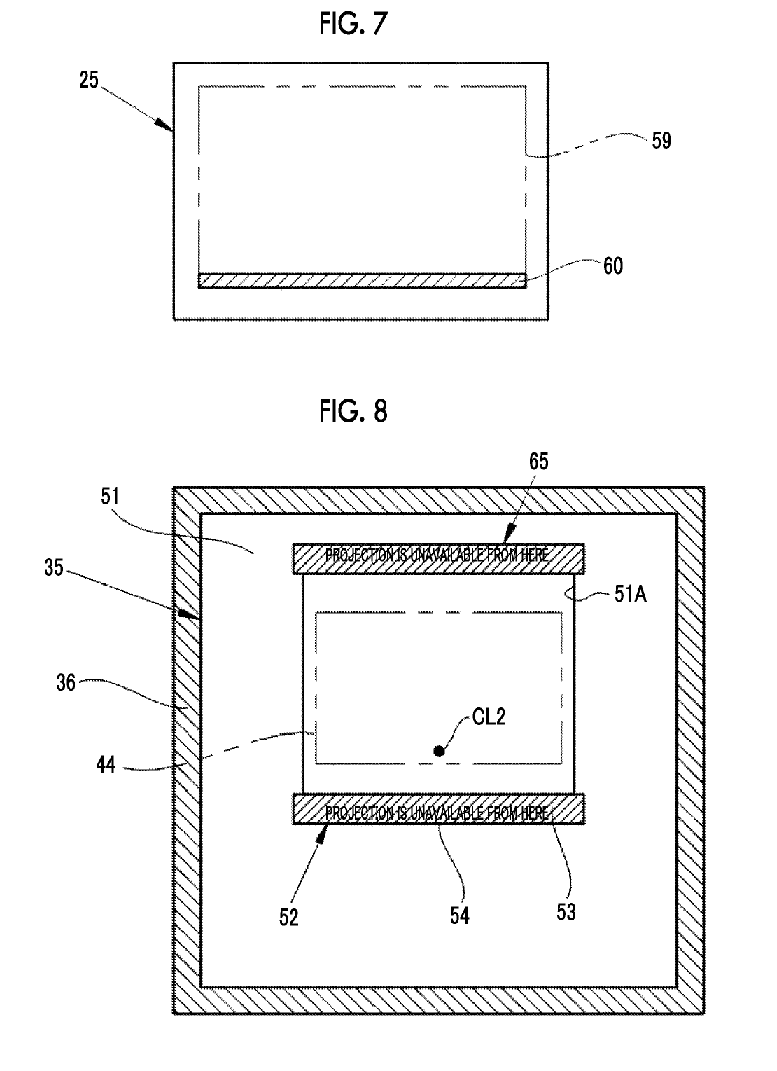

In a case in which the projection lens 11 is shifted beyond the projection limit and a shift distance is short, a strip-shaped warning mark image 60 having a red color, which is the base color of the warning mark 52, is displayed as shown in FIG. 7. Even in this case, due to the display of the red strip-shaped warning mark image 60, a user can easily know that the shift distance of the projection lens 11 exceeds the projection limit even though the characters of “Projection is unavailable from here” are not displayed.

In a case in which the projector 10 is used, the image of the image display panel 22 (see FIG. 1) is enlarged and projected onto the screen 25, which is provided on the upper side, from the back side of the projector 10 by the projection lens 11 as shown in FIG. 1. Since the lens can be shifted by the shift mechanism 24, the projection position can be changed in the vertical direction in a state in which the projector 10 is fixed.

Moreover, in a case in which the shift ratio (Y/H) is 0.5 as shown in FIG. 4, the linear optical axis CL10 of the projection lens 11 and the lower side of the projection image 59 can be made to coincide with each other.

In the first embodiment, the projection lens 11 is attachably and detachably mounted on the projector body 13 through the mounts 14 and 15 as shown in FIG. 1. However, instead of the fixing using the mounts 14 and 15, the first optical system 31 may be directly fixed to the shift mechanism 24 of the projector body 13. Further, the projection lens 11 is shifted in the vertical direction, but the projection lens 11 may be shifted in a horizontal direction instead of or in addition to this. In this case, it is preferable that a warning mark, which represents a projection limit in the horizontal direction, is provided instead of or in addition to the warning mark 52 that represents the projection limit in the vertical direction.

As shown in FIG. 5, the warning mark 52 is provided on one long side portion of the opening 51A of the mask 51 in the warning indicator member 35 of the first embodiment. However, in addition to the warning mark 52, a second warning mark 65 may be provided on the other long side portion of the opening 51A of the mask 51 as in Modification example 1 shown in FIG. 8. In each modification example and a second embodiment, the same components as the components of the first embodiment will be denoted by the same reference numerals as the reference numerals of the first embodiment and the repeated description thereof will be omitted.

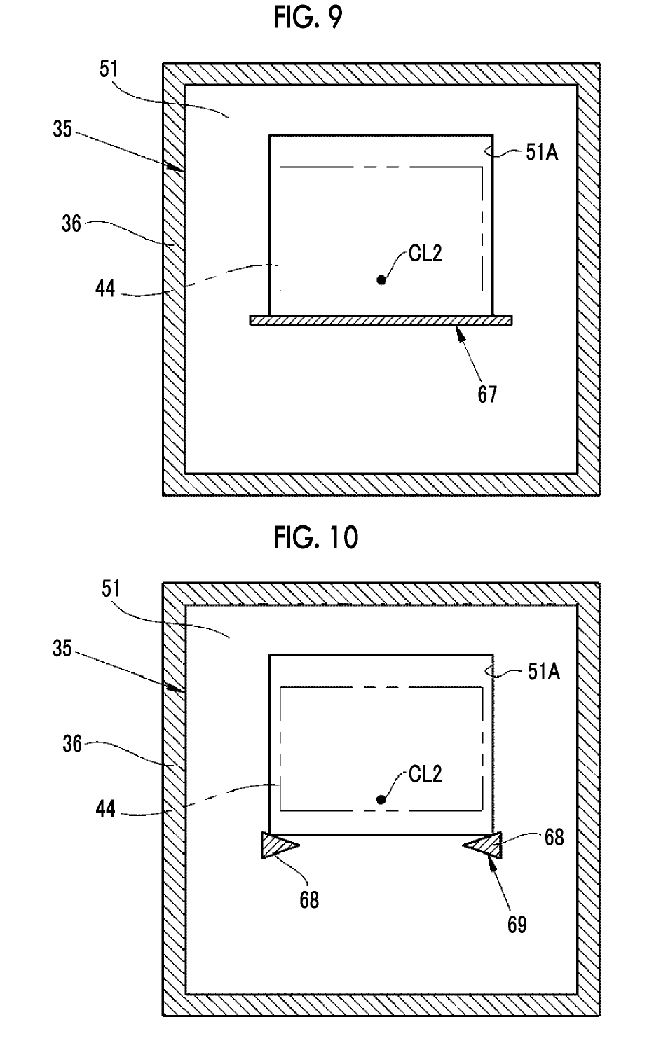

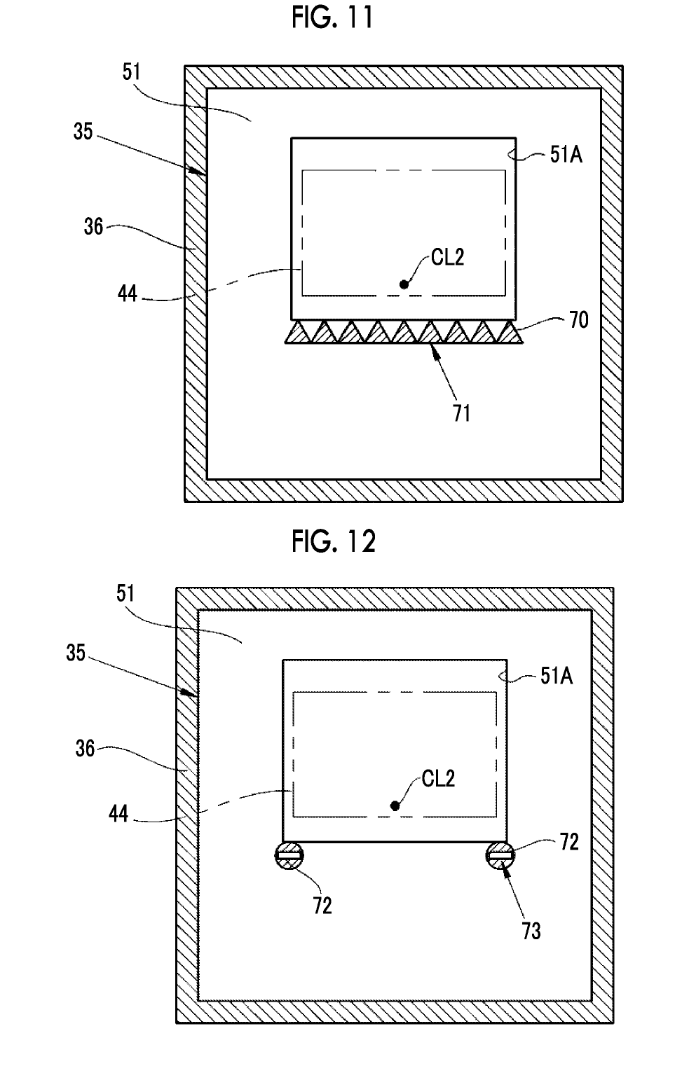

In Modification example 2 shown in FIG. 9, the transparent characters 54 for warning (see FIG. 5) are not provided and a strip-shaped warning mark 67 formed of a translucent member including, for example, a red base is provided. In Modification example 3 shown in FIG. 10, a warning mark 69 formed of a pair of isosceles triangles 68 of which apex angles face inward is provided instead of the strip-shaped warning mark 67 shown in FIG. 9. In Modification example 4 shown in FIG. 11, a warning mark 71 formed of a plurality of arranged triangles 70, which are translucent and of which a base color is red, is provided.

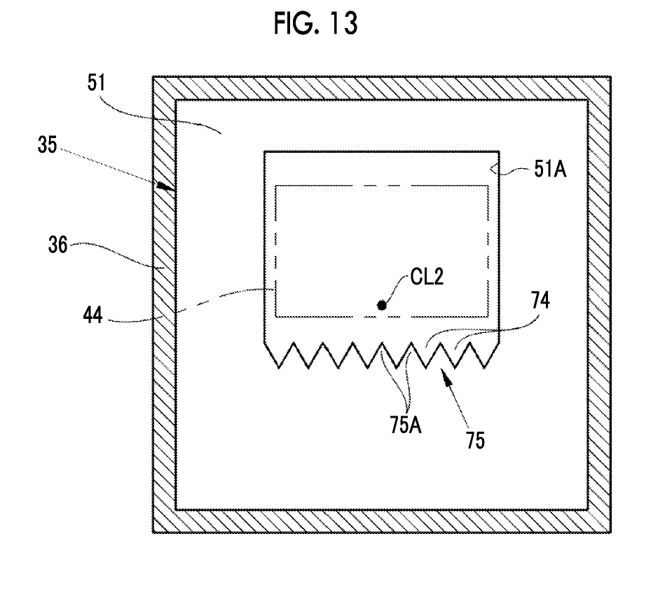

In Modification example 5 shown in FIG. 12, a warning mark 73 formed of, for example, no-entry marks 72, which are traffic-control signs, is provided instead of the warning mark 69 formed of the isosceles triangles 68 shown in FIG. 10. In Modification example 6 shown in FIG. 13, a warning mark 75, in which a plurality of triangular notches 74 are formed and which include a plurality of triangular protrusions 75A, is provided instead of the warning mark 71 that is formed of the translucent red triangles 70 shown in FIG. 11.

The warning marks 52, 65, 67, 69, 71, and 73 are formed of translucent red members, but a color to be used is not limited to a red color and various colors, which can warn a user, can be used. Further, the warning marks 52, 65, 67, 69, 71, and 73 may be formed of various patterns, which are forming in the shape of, for example, stripes, lattices, or the like with combinations of a plurality of colors, instead of one-color patterns. The warning mark is formed on one long side of the mask opening 51A in each of Modification examples 2 to 6, but may be formed only on the other long side of the mask opening 51A as in the case of the second warning mark 65 of Modification example 1. Furthermore, the warning marks may be formed on both the long sides.

In this embodiment, the excessive shift of the projection lens 11 can be simply recognized with a simple structure in which the warning indicator member 35 is merely used. Accordingly, it is possible to reliably prevent a part of the projection image from being missed. Therefore, this embodiment is beneficial in a case in which the projection lens 11 of which the excessive shift is particularly likely to occur and the shift distance is shorter than the lens shift distance of the projector body 13 is used.

### Second Embodiment

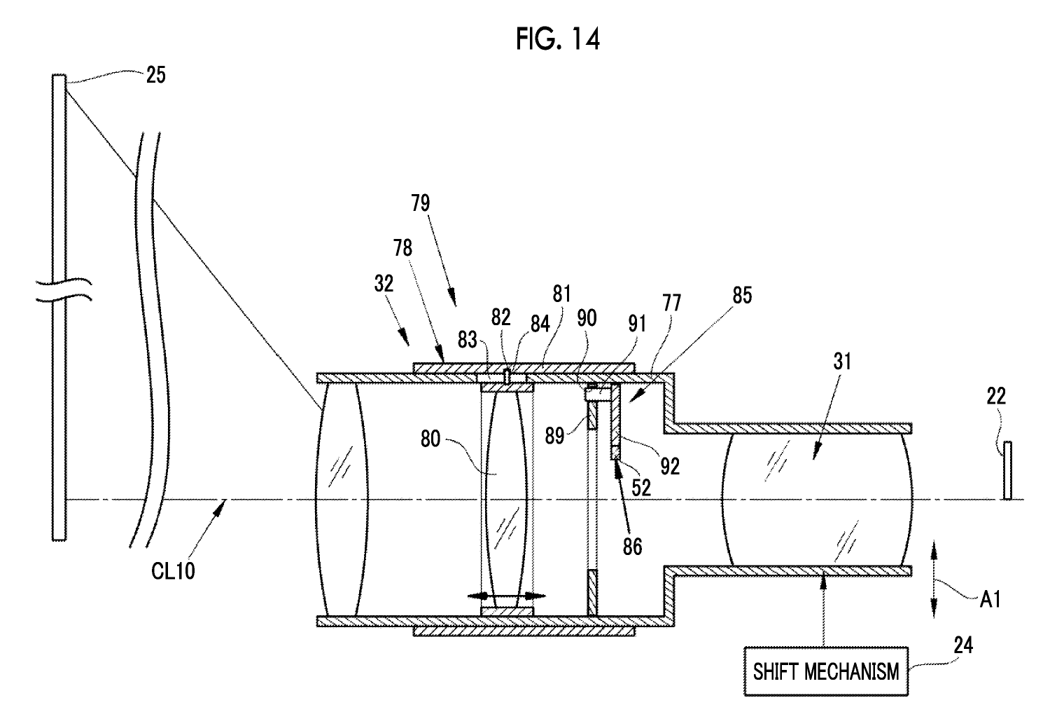

As shown in FIGS. 14 to 16, a second embodiment is an embodiment in which the invention is applied to a projection lens 79 including a zooming mechanism 78. The zooming mechanism 78 displaces, for example, a movable lens 80 of the second optical system 32 in an optical axis direction through cam grooves 82 and 83 and a cam pin 84 by the rotational movement of a zoom ring 81 to change a projection magnification. The cam groove 82 is formed on the inner peripheral surface of the zoom ring 81. The cam groove 83 is formed to pass through a lens barrel 77. In a case in which a projection magnification is changed by a zoom operation, a warning mark 52 of a warning indicator member 86 is shifted. An interlocking mechanism 85 is provided to correct the position of the warning indicator member 86.

The interlocking mechanism 85 corrects the position of the warning indicator member 86 while interlocking with the zoom operation. More specifically, the interlocking mechanism 85 displaces the warning indicator member 86 in a direction, which is orthogonal to the optical axis CL10, to position the warning mark 52 at a projection limit while interlocking with the displacement of the movable lens 80 in the direction of the optical axis CL10 that is performed by the zooming mechanism 78. For this purpose, the interlocking mechanism 85 includes a cam plate 89, a cam groove 90, a cam pin 91, an arm 92, and connection screws 93.

The cam plate 89 is disposed in the lens barrel 77 so as to be orthogonal to the linear optical axis CL10. Notches 77A are formed on the lens barrel 77 at appropriate intervals in a circumferential direction. The connection screws 93 are inserted into the notches 77A in a radial direction. The connection screws 93 are inserted into mounting holes of the zoom ring 81 and distal ends of the connection screws 93 are fixed to the outer peripheral surface of the cam plate 89. The cam plate 89 is connected to the zoom ring 81 by the connection screws 93. The length of each notch 77A in the circumferential direction of the lens barrel 77 is set to a length that allows the zoom ring 81 to be rotationally moved according to a rotation angle of 60° at the time of the zoom operation of the zoom ring 81.

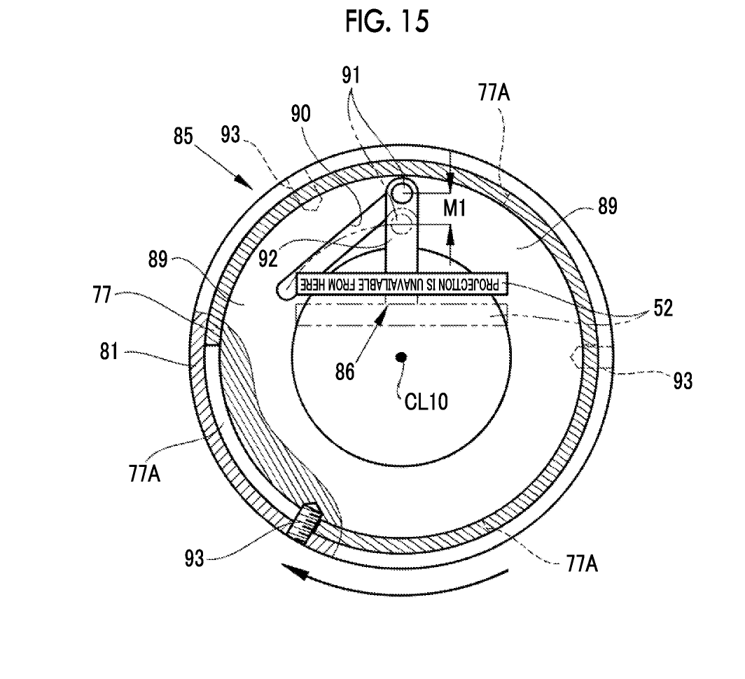

The cam plate 89 includes the cam groove 90. As shown in FIG. 15, the cam groove 90 is formed to be inclined with respect to the radius of the cam plate 89 so that the moving distance of the cam pin 91 becomes M1 in a case in which the cam plate 89 is rotated by an angle of, for example, 60°.

The cam pin 91 is mounted on the arm 92 so as to protrude from one end portion of the arm 92 in the optical axis direction. The warning indicator member 86 is mounted on the other end portion of the arm 92. A part of the cam pin 91 is stored in the cam groove 90. The warning indicator member 86 and the arm 92 are held so as to be movable only in a vertical direction by a guide member (not shown). Accordingly, in a case in which the cam groove 90 is displaced by the rotational movement of the zoom ring 81, the cam pin 91 is displaced in the vertical direction.

Since the cam pin 91 is integrated with the warning indicator member 86 through the arm 92, the warning indicator member 86 is moved in the vertical direction according to the rotational displacement of the zoom ring 81. In a case in which the angle of view of the projection image 59 is shifted by zooming, the warning indicator member 86 is also shifted from a position, which represents the projection limit, due to the shift of the angle of view. However, in the second embodiment, the warning indicator member 86 is positioned at a correct position, which represents the projection limit, by the interlocking mechanism 85.

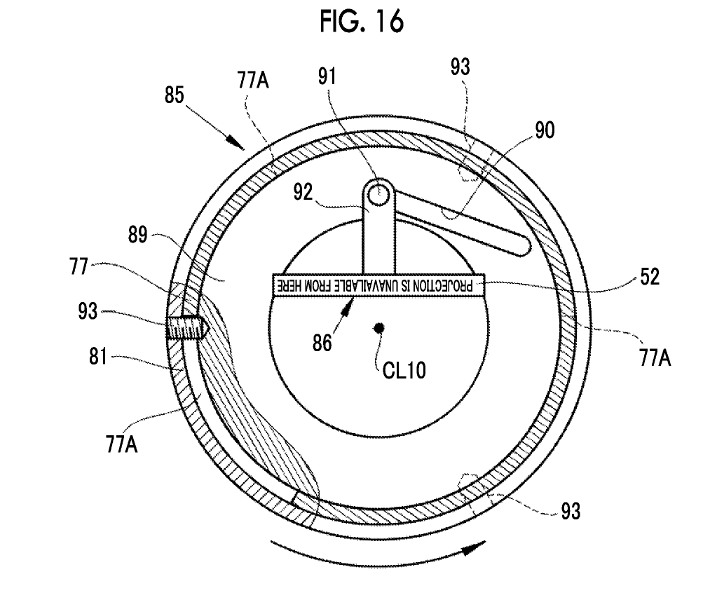

For example, as shown in FIG. 15, the warning indicator member 86 is positioned on the outside by the interlocking mechanism 85 in a case in which the second optical system 32 is set on the wide-side. Further, as shown in FIG. 16, the warning indicator member 86 is positioned on the inner side than the warning indicator member 86 positioned on the wide-side, by the interlocking mechanism 85 in a case in which the second optical system 32 is set on the telephoto-side.

The interlocking mechanism 85 has included the cam plate 89, the cam groove 90, the cam pin 91, the arm 92, and the connection screws 93, but the interlocking mechanism 85 has only to be capable of moving the warning indicator member 86 while interlocking with the zoom operation and may use a link mechanism or other shift mechanisms. Further, the projection lens 79 including the linear optical axis CL10 has been exemplified in the second embodiment, but the projection lens 11 including a U-shaped optical axis as in the first embodiment may be applied. Even in this case, a zooming mechanism and an interlocking mechanism are provided and the position of the warning indicator member 86 is corrected according to a zoom operation.

The second optical system has a zoom function in the second embodiment, but the first optical system may have a zoom function. Even in this case, as in the second embodiment, the warning indicator member is moved while interlocking with a zoom operation.

In each embodiment, the mounts 14 and 15 have been shifted in the vertical direction by the shift mechanism 24. However, instead of this structure, the light source 21 and the image display panel 22 may be shifted in the vertical direction by the shift mechanism 24. Further, a direction in which the projection lens 11 or the image display panel 22 is to be shifted by the shift mechanism 24 may be the horizontal direction other than the vertical direction or may be a two-dimensional direction of the vertical direction and the horizontal direction.

A transmission-type liquid crystal panel has been used as the image display panel 22 in each of the embodiments, but a reflective liquid crystal panel may be used. In this case, the light source 21 is disposed on the front side of the image display panel 22 and simultaneously projects light having three colors of RGB or emits and projects light by time sharing. Further, in a case in which a digital micromirror device (DMD) is used as the image display panel 22, the light source 21 is disposed on the front side of the image display panel 22 and LEDs corresponding to three colors of RGB emit light by time sharing in synchronization with timings at which the DMD forms an image having three colors.

The projector 10 can be used in a state in which the projector 10 is disposed on a table or is suspended from the ceiling or the like. An example in which an image is projected onto the screen 25 has been described, but the projection surface is not limited to the screen 25 and the projector can be used as a projector that projects an image onto various projection surfaces.

### EXPLANATION OF REFERENCES

10: projector
11: projection lens
13: projector body
14, 15: mount
20: housing
21: light source
22: image display panel
22A: image display surface
23: control unit
24: shift mechanism
25: screen
26A: shift dial
26B: focus dial
27: lens holding block
28: guide frame
28A: guide groove
29: drive unit
31: first optical system
32: second optical system
33: first mirror
34: second mirror
35: warning indicator member
36: lens barrel
41: first lens
42: second lens
43: imaging plane
44: image frame
45: third lens
46: fourth lens
47: fifth lens
48: sixth lens
51: mask
51A: opening
52: warning mark
53: red filter
54: transparent characters
59: projection image
60: warning mark image
65: second warning mark
67: warning mark
68: isosceles triangle
69: warning mark
70: triangle
71: warning mark
72: no-entry mark
73: warning mark
74: notch
75: warning mark
75A: protrusion
77: lens barrel
77A: notch
78: zooming mechanism
79: projection lens
80: movable lens
81: zoom ring
82: cam groove
83: cam groove
84: cam pin
85: interlocking mechanism
86: warning indicator member
89: cam plate
90: cam groove
91: cam pin
92: arm
93: connection screw
A1: arrow
CL1: first optical axis
CL10: linear optical axis
CL2: second optical axis
CL3: third optical axis
Y: distance
H: length of image display panel

What is claimed is:

1. A projection lens that projects an image of an image display panel onto a projection surface and is used for a projector shifting one of the image display panel and the projection lens in a direction crossing an optical axis to adjust a projection position of the image on the projection surface, the projection lens comprising:
a first optical system that forms the image of the image display panel;
a second optical system that projects the image, which is formed by the first optical system, onto the projection surface; and
a warning indicator member that displays an outside of a projection range of the image depending on the shift of one of the image display panel and the projection lens in a direction crossing an optical axis of the first optical system.

2. The projection lens according to claim 1,
wherein the warning indicator member is provided on an imaging plane on which the image is formed by the first optical system.

3. The projection lens according to claim 1,
wherein the warning indicator member includes a mask that includes an opening regulating the projection of the image, and a warning mark that is formed at a portion of the warning indicator member where the image is hidden by the mask due to the shift of one of the image display panel and the projection lens.

4. The projection lens according to claim 2,
wherein the warning indicator member includes a mask that includes an opening regulating the projection of the image, and a warning mark that is formed at a portion of the warning indicator member where the image is hidden by the mask due to the shift of one of the image display panel and the projection lens.

5. The projection lens according to claim 3,
wherein the second optical system includes a zooming mechanism that displaces some lenses in an optical axis direction to change a projection magnification, and an interlocking mechanism that displaces the warning indicator member in the direction, which crosses the optical axis, to position the warning mark at the portion of the warning indicator member where the image is hidden by the mask while interlocking with the displacement of the some lenses in the optical axis direction that is performed by the zooming mechanism.

6. The projection lens according to claim 4,
wherein the second optical system includes a zooming mechanism that displaces some lenses in an optical axis direction to change a projection magnification, and an interlocking mechanism that displaces the warning indicator member in the direction, which crosses the optical axis, to position the warning mark at the portion of the warning indicator member where the image is hidden by the mask while interlocking with the displacement of the some lenses in the optical axis direction that is performed by the zooming mechanism.

7. The projection lens according to claim 3,
wherein the first optical system includes a zooming mechanism that displaces some lenses in an optical axis direction to change a projection magnification, and an interlocking mechanism that displaces the warning indicator member in the direction, which crosses the optical axis, to position the warning mark at the portion of the warning indicator member where the image is hidden by the mask while interlocking with the displacement of the some lenses in the optical axis direction that is performed by the zooming mechanism.

8. The projection lens according to claim 4,
wherein the first optical system includes a zooming mechanism that displaces some lenses in an optical axis direction to change a projection magnification, and an interlocking mechanism that displaces the warning indicator member in the direction, which crosses the optical axis, to position the warning mark at the portion of the warning indicator member where the image is hidden by the mask while interlocking with the displacement of the some lenses in the optical axis direction that is performed by the zooming mechanism.

9. The projection lens according to claim 1, further comprising:
a first reflective member that is disposed so as to be inclined with respect to a first optical axis of the first optical system and reflects the first optical axis to form a second optical axis;
a second reflective member that is provided in the second optical system, is disposed so as to be inclined with respect to the second optical axis, and reflects the second optical axis to form a third optical axis parallel to the first optical axis in a plane including the first optical axis and the second optical axis; and
a lens barrel that holds the first optical system, the first reflective member, the second reflective member, the second optical system, and the warning indicator member.

10. The projection lens according to claim 2, further comprising:
a first reflective member that is disposed so as to be inclined with respect to a first optical axis of the first optical system and reflects the first optical axis to form a second optical axis;
a second reflective member that is provided in the second optical system, is disposed so as to be inclined with respect to the second optical axis, and reflects the second optical axis to form a third optical axis parallel to the first optical axis in a plane including the first optical axis and the second optical axis; and
a lens barrel that holds the first optical system, the first reflective member, the second reflective member, the second optical system, and the warning indicator member.

11. The projection lens according to claim 3, further comprising:
a first reflective member that is disposed so as to be inclined with respect to a first optical axis of the first optical system and reflects the first optical axis to form a second optical axis;
a second reflective member that is provided in the second optical system, is disposed so as to be inclined with respect to the second optical axis, and reflects the second optical axis to form a third optical axis parallel to the first optical axis in a plane including the first optical axis and the second optical axis; and
a lens barrel that holds the first optical system, the first reflective member, the second reflective member, the second optical system, and the warning indicator member.

12. The projection lens according to claim 4, further comprising:
a first reflective member that is disposed so as to be inclined with respect to a first optical axis of the first optical system and reflects the first optical axis to form a second optical axis;
a second reflective member that is provided in the second optical system, is disposed so as to be inclined with respect to the second optical axis, and reflects the second optical axis to form a third optical axis parallel to the first optical axis in a plane including the first optical axis and the second optical axis; and
a lens barrel that holds the first optical system, the first reflective member, the second reflective member, the second optical system, and the warning indicator member.

13. The projection lens according to claim 5, further comprising:
a first reflective member that is disposed so as to be inclined with respect to a first optical axis of the first optical system and reflects the first optical axis to form a second optical axis;
a second reflective member that is provided in the second optical system, is disposed so as to be inclined with respect to the second optical axis, and reflects the second optical axis to form a third optical axis parallel to the first optical axis in a plane including the first optical axis and the second optical axis; and
a lens barrel that holds the first optical system, the first reflective member, the second reflective member, the second optical system, and the warning indicator member.

14. The projection lens according to claim 6, further comprising:
a first reflective member that is disposed so as to be inclined with respect to a first optical axis of the first optical system and reflects the first optical axis to form a second optical axis;
a second reflective member that is provided in the second optical system, is disposed so as to be inclined with respect to the second optical axis, and reflects the second optical axis to form a third optical axis parallel to the first optical axis in a plane including the first optical axis and the second optical axis; and
a lens barrel that holds the first optical system, the first reflective member, the second reflective member, the second optical system, and the warning indicator member.

15. The projection lens according to claim 7, further comprising:
a first reflective member that is disposed so as to be inclined with respect to a first optical axis of the first optical system and reflects the first optical axis to form a second optical axis;
a second reflective member that is provided in the second optical system, is disposed so as to be inclined with respect to the second optical axis, and reflects the second optical axis to form a third optical axis parallel to the first optical axis in a plane including the first optical axis and the second optical axis; and
a lens barrel that holds the first optical system, the first reflective member, the second reflective member, the second optical system, and the warning indicator member.

16. The projection lens according to claim 8, further comprising:
a first reflective member that is disposed so as to be inclined with respect to a first optical axis of the first optical system and reflects the first optical axis to form a second optical axis;
a second reflective member that is provided in the second optical system, is disposed so as to be inclined with respect to the second optical axis, and reflects the second optical axis to form a third optical axis parallel to the first optical axis in a plane including the first optical axis and the second optical axis; and
a lens barrel that holds the first optical system, the first reflective member, the second reflective member, the second optical system, and the warning indicator member.

17. A projector comprising:
the projection lens according to claim 1;
the image display panel that displays the image;
a light source that illuminates the image display panel;
a shift mechanism that shifts one of the image display panel and the projection lens in the direction crossing the optical axis; and
a housing that stores the image display panel, the light source, and the shift mechanism.

18. The projector according to claim 17,
wherein the projection lens is attachably and detachably mounted on the housing.

19. A projector comprising:
the projection lens according to claim 2;
the image display panel that displays the image;
a light source that illuminates the image display panel;
a shift mechanism that shifts one of the image display panel and the projection lens in the direction crossing the optical axis; and
a housing that stores the image display panel, the light source, and the shift mechanism.

20. The projector according to claim 19,
wherein the projection lens is attachably and detachably mounted on the housing.
